(19) United States
(12) Patent Application Publication
(10) Pub. No.: US 2026/0302606 A1
(43) Pub. Date: Oct. 1, 2026

(54) STRUCTURE FOR IMPROVING ISOLATION BETWEEN ANTENNAS, AND ANTENNA SYSTEM

(71) Applicant: HUAWEI TECHNOLOGIES CO., LTD., SHENZHEN (CN)

(72) Inventor: Jamal Mohamed Ahmouda ZAID, Kanata (CA)

(73) Assignee: HUAWEI TECHNOLOGIES CO., LTD., SHENZHEN (CN)

(21) Appl. No.: 19/320,426

(22) Filed: Sep. 5, 2025

Related U.S. Application Data
(60) Provisional application No. 63/778,227, filed on Mar. 26, 2025.

(51) Int. Cl. H01Q 1/52

(52) U.S. Cl. CPC H01Q 1/523

(57) ABSTRACT

A unit cell for increasing isolation between antennas makes use of a multi-layer configuration where a top layer is formed into the shape of a notched square with a plurality of vias, positioned atop a solid layer having a lower di-electric constant than the top layer, which in turn is positioned above a metallic layer. In some embodiments, further third and fourth layers are positioned on the other side of the metallic layer to create a symmetric stacking of layers. The first and fourth layers are rotated 180° from each other about an axis of symmetry. When interposed between either cross-polarized or co-polarized antennae, the unit cell absorbs electromagnetic radiation between the antennae to provide a number of different operating frequency bands. The isolation and number of frequency bands may be a function of the number and placement of vias and the size, shape and dimensions of the layers.

### CROSS REFERENCE TO RELATED APPLICATIONS

This application claims the benefit of priority to U.S. Provisional Patent Application Ser. No. 63/778,227 filed on Mar. 26, 2025, the contents of which are incorporated herein by reference in their entirety.

### BACKGROUND

Conventional communication systems make use of transmitters and receivers that operate using different time-frequency resources to avoid interference. In some systems, transmitters and receivers operate in different frequency bands, while in other systems a particular frequency band may be used for both transmit and receiver directions but at different times. This allows for mobile devices to schedule uplink transmissions for define transmission windows. This is an inefficient use of the limited spectral resources. These half-duplex transmission systems have been designed around a simple implementation where network infrastructure does not need to account for the receivers being overwhelmed by the vastly more powerful transmitted signal making the signal-to-noise ratio on the received channel notably worse. Full-duplex communication systems, on the other hand, support simultaneous transmission and reception on the same time-frequency resources. This requires a more complex implementation but provides an increased spectral efficiency.

Improved isolation between transmit and receive antennas is typically desirable in full-duplex systems to mitigate self-interference in the transmitted and received signals. This reduces the noise floor of the received channel before complex processing is further applied to reduce the interference. Thus, improving the isolation between the transceiver becomes an important and appealing topic for researchers.

### SUMMARY

In general, example implementations of the present disclosure provide a unit cell for isolation between antennas, an antenna system, and a communication device.

In a first aspect of the present disclosure, a unit cell is provided. The unit cell comprises first, second and metallic layers. The first layer has a first dielectric constant and is shaped to define a central void. The first layer further has a set of vias surrounding the central void. The second layer has a second dielectric constant lower than the first dielectric constant, having a surface area greater than a surface area of the first layer, and supporting the first layer. The metallic layer is affixed to the second layer opposite the first layer.

In an embodiment of the first aspect, the first and second layers are squares. In another embodiment, the central void is a square. In a further embodiment, each via within the set of vias is equally spaced around the central void. In another embodiment, each via within the set of vias is at least partially filled with a metal, that is optionally the same composition as the metal within the metallic layer. In other embodiments, each via in the set of vias has the same cross-sectional shape, which is optionally circular. In a further embodiment, the first layer further comprises a slot exposing the central void, and optionally the vias are equidistant from each neighboring via, except for the vias on opposite sides of the slot. In some embodiments, the first layer is centered upon the second layer. In other embodiments, the metallic layer is the same size and surface area as the second layer.

In a further embodiment of the first aspect, the unit cell further comprises a third layer affixed to the metallic layer and opposite the second layer, having a third dielectric constant and a fourth layer, supported by the third layer, having a dielectric constant higher than the third dielectric constant, shaped to define a central void, and having a set of vias surrounding the central void. In some embodiments, the first and fourth layer have the same dielectric constant, and wherein the second and third layers have the same dielectric constant. In other embodiments, each of the first and fourth layers are squares defining a square shaped central void. In another embodiment, each via in the plurality of metal vias has a circular cross section of 3.5 mm, and adjacent vias are 6.48 mm apart.

In a second aspect of the present disclosure, there is provided a communication device comprising an antenna system, the antenna system comprising: a first antenna, a second antenna, and a unit cell interposed therebetween. The unit cell further comprises a first layer, a second layer and a metallic layer. The first layer has a first dielectric constant, is shaped to define a central void, and having a set of vias surrounding the central void. The second layer has a second dielectric constant lower than the first dielectric constant, having a surface area greater than a surface area of the first layer, and is positioned to support the first layer. The metallic layer is affixed to the second layer opposite the first layer, wherein the unit cell is placed between the first and second antennas so that it is perpendicular to a plane within which the first and second antennas reside.

In a third aspect of the present disclosure, there is provided an antenna system. The antenna system comprises a first antenna, a second antenna, and a unit cell interposed therebetween. The unit cell further comprises a first layer, a second layer and a metallic layer. The first layer has a first dielectric constant, is shaped to define a central void, and has a set of vias surrounding the central void. The second layer has a second dielectric constant lower than the first dielectric constant, has a surface area greater than a surface area of the first layer, and supports the first layer. The metallic layer is affixed to the second layer opposite the first layer. The unit cell is positioned between the first and second antennas, and is perpendicular to a plane containing the first and second antennas.

In embodiments of the second and third aspects, the first antenna is arranged to be one of co-polarized and cross-polarized, with the second antenna. In another embodiment, the unit cell is interposed between the first antenna and the second antenna, to absorb electromagnetic waves transmitted between the first and second antennas to provide 27 dB of isolation.

Those skilled in the art will appreciate that recited embodiments may be associated with any or all of the described aspects, where appropriate. Furthermore, different embodiments are intended to be combined with each other, where not mutually exclusive.

According to another aspect, a unit cell in an antenna system is disclosed. The unit cell includes: a first layer comprising a plurality of metal vias arranged in a notched square, where a dielectric constant of a material in the first layer is larger than a threshold; and a second layer being under the first layer, wherein a dielectric constant of a material in the second layer is smaller than that of the material in the first layer.

According to a further aspect, an antenna system is disclosed. The antenna system includes at least two antennas, and a unit cell as in the first aspect. The unit cell is placed vertical between a first and second antennas in the antenna system.

According to another aspect, a communication device is disclosed. The communication device includes an antenna system as in the second aspect. For example, the communication device may be a network device such as base station, or a terminal device such as user equipment.

It is to be understood that the summary section is not intended to identify key or essential features of implementations of the present disclosure, nor is it intended to be used to limit the scope of the present disclosure. Other features of the present disclosure will become easily comprehensible through the following description.

### BRIEF DESCRIPTION OF THE DRAWINGS

Further features and advantages of the present disclosure will become apparent from the following detailed description, taken in combination with the appended drawings, in which:

FIG. 1A is an exploded perspective view of a unit cell according to an embodiment of the present disclosure;

FIG. 1B is a top view of a unit cell according to an embodiment of the present disclosure;

FIG. 1C is a side view of a unit cell according to an embodiment of the present disclosure;

FIG. 1D is a perspective view of a unit cell according to an embodiment of the present disclosure;

FIG. 2A is a perspective view of a unit cell between a transmitter and receiver according to an embodiment of the present disclosure;

FIG. 2B is a pair of graphs plotting an S-Parameter of the unit cell against frequency according to simulated results of an embodiment of the present disclosure;

FIG. 2C is a graph plotting an S-Parameter of the unit cell against frequency according to simulations of an embodiment of the present disclosure;

FIG. 3A is a schematic illustration of co-polarized antennae according to an embodiment of the present disclosure;

FIG. 3B is a schematic illustration of co-polarized antenna with an interposed unit cell according to an embodiment of the present disclosure;

FIG. 4A is a graph plotting an S-Parameter of the co-polarized antennas of FIG. 3A against frequency according to an embodiment of the present disclosure;

FIG. 4B is a graph plotting an S-Parameter of the co-polarized antennae of FIGS. 3A and 3B against frequency according to an embodiment of the present disclosure;

FIG. 4C is a graph contrasting the S-Parameters of the co-polarized antenna of FIGS. 3A and 3B with comparison at specific frequency bands according to an embodiment of the present disclosure;

FIG. 5A is a schematic illustration of cross polarized antennae according to an embodiment of the present disclosure;

FIG. 5B is a schematic illustration of cross polarized antenna with an interposed unit cell according to an embodiment of the present disclosure;

FIG. 6A is a graph plotting an S-Parameter of the cross-polarized antennas of FIG. 5A against frequency according to an embodiment of the present disclosure;

FIG. 6B is a graph plotting an S-Parameter of the cross-polarized antennas of FIGS. 5A and 5B against frequency according to an embodiment of the present disclosure;

FIG. 6C is a graph contrasting the S-Parameters of the cross-polarized antennae of FIGS. 5A and 5B with a comparison at specific frequency bands according to an embodiment of the present disclosure;

FIG. 7 is a graph contrasting the S-parameters of antenna configurations vs. frequency according to 4 embodiments of the present disclosure;

FIG. 8A is a schematic illustration of a top view of co-polarized antennas with an interposed unit cell showing energy absorption within the unit cell according to an embodiment of the present disclosure;

FIG. 8B is a schematic illustration of a bottom view of co-polarized antennas with an interposed unit cell showing energy absorption within the unit cell according to an embodiment of the present disclosure;

FIG. 8C is a schematic illustration of a right-side view of co-polarized antennas with an interposed unit cell showing energy absorption within the unit cell according to an embodiment of the present disclosure;

FIG. 8D is a schematic illustration of a left-side view of co-polarized antennas with an interposed unit cell showing energy absorption within the unit cell according to an embodiment of the present disclosure;

FIG. 9A is a schematic illustration of a top view of cross-polarized antennas with an interposed unit cell showing energy absorption within the unit cell according to an embodiment of the present disclosure;

FIG. 9B is a schematic illustration of a bottom view of cross-polarized antennas with an interposed unit cell showing energy absorption within the unit cell according to an embodiment of the present disclosure;

FIG. 9C is a schematic illustration of a right-side view of cross-polarized antennas with an interposed unit cell showing energy absorption within the unit cell according to an embodiment of the present disclosure; and

FIG. 9D is a schematic illustration of a left-side view of cross-polarized antennas with an interposed unit cell showing energy absorption within the unit cell according to an embodiment of the present disclosure.

It will be noted that throughout the appended drawings attempts have been made to ensure that like features are identified by like reference numerals.

### DETAILED DESCRIPTION

Providing isolation between the transmitter and receiver antennas is desirable in full duplex systems, including in Multiple Input Multiple Output (MIMO) antenna systems.

Different solutions have been disclosed to enhance the isolation between the transmitter and receiver antennas. One solution utilized a dual layer split ring resonator (SRR) to increase the isolation by 15 dB, and another solution employed SRR to improve the isolation by 10 dB. A dual-layer metamaterial absorber structure has been used to enhance the isolation by 11 dB. However, these solutions operate in only one frequency band, and the achieved improvement in isolation has not exceeded 23 dB.

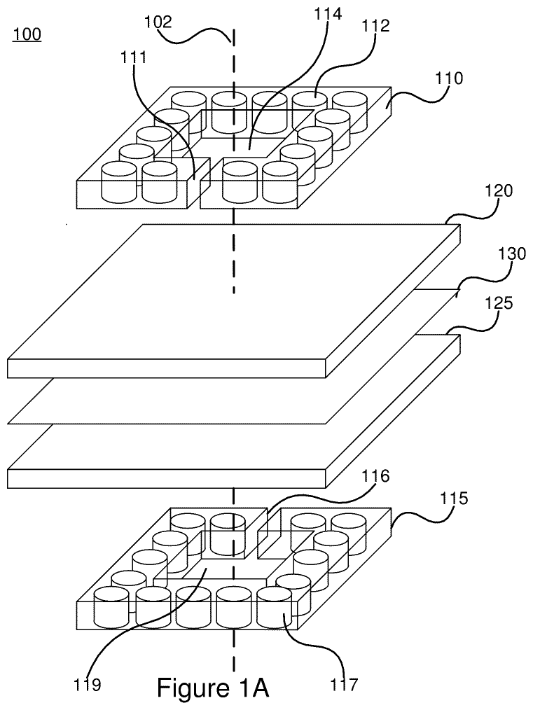

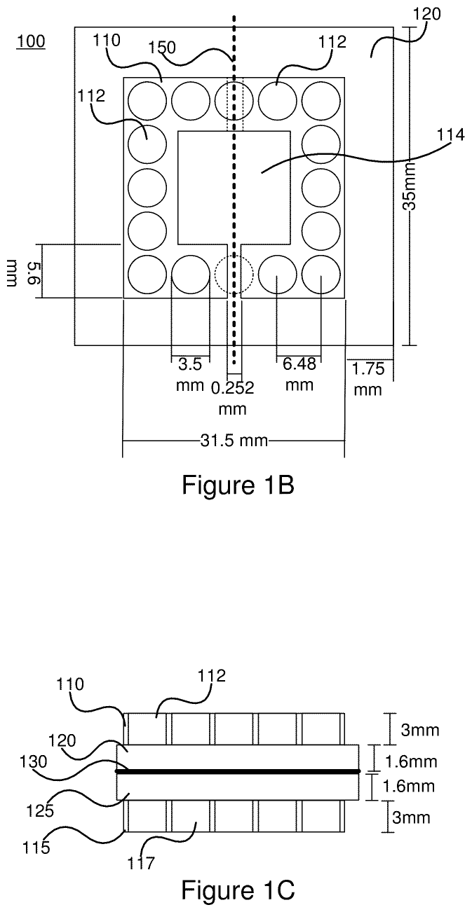

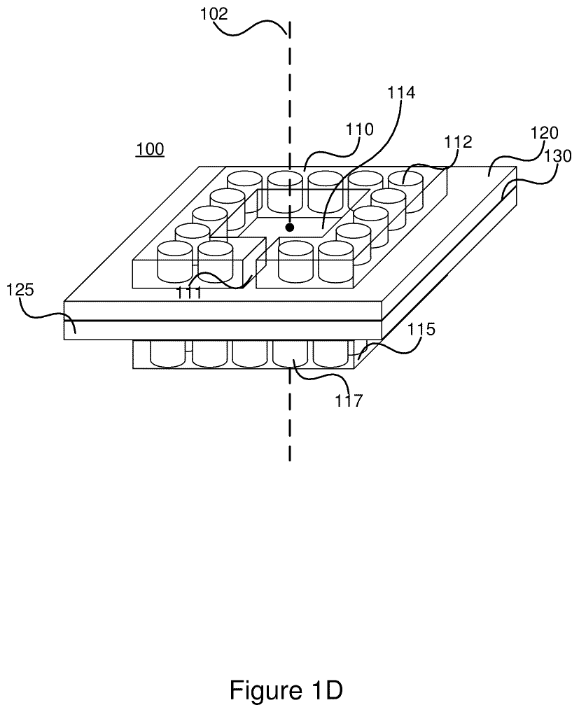

The present disclosure discloses a unit cell 100 having a structure at least for improving isolation between the transmitter and the receiver antennas. FIG. 1A illustrates a schematic of the unit cell 100 having a central axis 102. As illustrated, the unit cell 100 is comprised of 5 layers. Starting from the illustrated top position, the unit cell 100 includes a first layer 110, a second layer 120, a metal layer 130, a third layer 125, and a fourth layer 115. The second layer 120 and third layer 125 are symmetric with respect to the metal layer 130. The first layer 110 and the fourth layer 115 are rotationally symmetric by 180 degrees with respect to the central axis 102.

In some implementations, a first material may be used for the first layer 110 and the fourth layer 115, and a second material may be used for the second layer 120 and the third layer 125. In some implementations, a dielectric constant of the first material is larger than that of the second material. This results in a structure where a material with a first dielectric constant is used for the outmost layers, a material with a second dielectric constant, less than the first dielectric constant, is used for the next innermost layers, and the middle layer is a metallic material. Thus, the second and third layers have lower dielectric constants than adjacent layers. In some embodiments, the first and fourth layers may have different material compositions and may thus have different dielectric constants. In some embodiments, the second and third layers may have different material compositions and may thus has different dielectric constants.

In some implementations, the second layer 120 and the third layer 125 may be formed by a material with a dielectric constant that is less than a threshold. In some implementations, the threshold (represented as th) may be a dielectric constant a value in a range 4.4<th<10. In some examples, the threshold may be any of: 5, 6, 7, 8, 9, or another value. For example, the material in the second layer 120 and the third layer 125 may have a dielectric constant of 4.4.

In some implementations, the unit cell 100 may include an upper part and a lower part, which are rotationally symmetric by 180 degrees with respect to the central axis 102. The upper part includes the first layer 110 and the second layer 120, and the lower part includes the third layer 125 and the fourth layer 115. In some examples, the third layer 125 and the second layer 120 are rotationally symmetric by 180 degrees with respect to the metal layer 130, and the fourth layer 115 and the first layer 110 are rotationally symmetric by 180 degrees with respect to the metal layer 130.

As illustrated, the unit cell 100 includes the first layer 110 in the form of a notched square. Reference to a notched square should be understood to refer to the illustrated structure of layer 110 which is shown as a square surrounding a void, with a gap or slot 111 (the notch) within one of the walls of the square. The first layer 110 has a dielectric constant larger than the threshold (e.g. it has a higher dielectric constant than the second layer 120), and has defined within it, a set of vias. As illustrated, these vias 112 may be circular in cross section and filled with a metal. In the illustrated embodiment, the first layer 110 takes the form of a notched square structure with multiple metal vias 112 that defines an interval void 114 within the first layer 110. The fourth layer 115 has a same structure as the first layer 110, and is rotationally symmetrical by 180 degrees with respect to the central axis 102.

In some implementations, the material in the first layer 110 and the fourth layer 115 are formed from materials that have a dielectric constant larger than the threshold. In one embodiment, the dielectric constant of the material in the first layer 110 and the fourth layer 115 may be 10.

As the metal vias1 12 are arranged in high dielectric material 110/115, this unit cell may be referred to as an embedded metal via in dielectric split ring resonator (EMVDSRR) unit cell. In other words, the unit cell has an EMVDSRR structure.

FIG. 1B illustrates a top view of the unit cell 100, and FIG. 1C illustrates a side view of the unit cell 100. It should be understood that the sizing of elements in the illustrated embodiment is best understood with reference to the measurements provided. The sizes of certain features, such as the gap or notch 111, may be exaggerated in the drawings for the sake of clarity.

As illustrated, the second layer 120 and the third layer 125 may take the shape of a square with a length of 35 mm per side. The size of the first/fourth layer 110/115 is shown as being smaller than the size of the second/third layer 120/125. For example, a distance from an outer edge of the first/fourth layer 110/115 to an outer edge of the second/third layer 120/125 may be 1.75 mm in the illustrated embodiment. For example, an outer length of the outer square of the first/fourth layer 110/115 may be 31.5 mm.

As illustrated, the plurality of metal vias may be arranged within each of layers 110 and 115. The vias in layer 110 are denoted as 112, while those in layer 115 are denoted as 117. A diameter of a metal via 112, 117 as illustrated in the embodiment of FIG. 1B is 3.5 mm, and a distance between two adjacent vias 112, 117 is 6.48 mm center-to-center. In the illustrated embodiment, there are 15 metal vias 112 in the first layer 110, and also 15 metal vias 117 in the fourth layer 115. It should be understood that the distance between two vias on opposing sides of slot 111 is larger than 6.48 mm. As the slot 111 is aligned at the location of what would otherwise be a via, the adjacent vias 112 are 6.48*2=12.96 mm apart center-to-center. Similarly, vias 117 adjacent to the slot/notch of layer 115 would also be spaced apart by twice the distance as other adjacent vias 117.

In some implementations, a width of each side of the notched square of layer 110 is 5.6 mm. A slot 111 (or notch) through one of sides of the notched square of layer 110 has a slot width of 0.2525 mm.

As can be seen, the line 150 can be regarded a symmetric axis for the top view.

As illustrated, a thickness of the first layer 110 and the fourth layer 115 is 3 mm, and a thickness of the second layer 120 and the third layer 125 is 1.6 mm.

It is to be understood that any size above may be replaced by another value. In some implementations, for a size x mm, it can be replaced by any value in a range from x−x*ε to x+x*ε, where ε is an error ratio, such as 1%, 2%, 5%, or another value. It should further be understood that in some embodiments there is no need for symmetry in the thicknesses of the first and fourth layer, or in the second and third layers.

FIG. 1D illustrates the unit cell 100 with the layers stacked together as opposed to the exploded view of FIG. 1A.

It should be noted that the examples of the unit cell shown in FIGS. 1A-1D are only for illustration without any limitation. For example, although the shape (e.g., seen from the top view) is illustrated as square, it may have any shape, such as rectangle, circle, etc. For example, the vias arranged in the first layer 110 and the fourth layer 115 may have any shape, such as square etc. For example, the diameter of each via may be larger or smaller than that illustrated, and the number of vias may be larger or smaller than 15 in the first layer 110 (or the fourth layer 115). For example, the first/fourth layer 110/115 may have any shape (e.g., square, rectangle, circle, ovoid, etc.) having a slot 111/116 and defining an interval void 114/116. The slot 111/116 may take the form of any number of different shapes that provide a passage through the layer 110/115 to the internal void 114. The internal void 115/116 may take the shape of the layer 110/115, or it may have any number of other shapes including circular/cylindrical shapes or any shapes like a star etc. The vias 112/117 may be placed within layer 110/115 so that they surround, or substantially surround the void 114/116 in some embodiments. Each via 112/117 can be of any number of different shapes, and in some embodiments, they may be filled with a metal, while in others they may be unfilled, or filled with a non-metal. In some embodiments the vias may only be partially filled with the metal or non-metal material.

For ease of description, the following description are provided based on the sizes and shapes that are illustrated in FIGS. 1A-1D.

The high dielectric material (e.g., in the first layer 110 and the fourth layer 115) has the ability to confine and store electromagnetic waves, while the embedded vias 112/117 function as inductors and capacitors. This creates a structure in which electromagnetic waves around the vias and between them are captured and stored. As layers 110/115 are designed to not be perfect conductors, the energy of the captured electromagnetic waves will be converted to a different form or frequency. This allows, in the illustrated embodiment, for the captured electromagnetic waves to be re-emitted from the unit cell 100 as heat. In other embodiments, the captured electronic waves can be differently re-emitted such as in a frequency band sufficiently different than the received electromagnetic wave to prevent contamination of a signal received at a receiver. Moreover, the size, shape and placement of vias 112/117 within the layer 110/115 achieve multiple operational frequency bands.

The above described EMVDSRR structure can achieve up to six frequency operating bands. The structure achieves high isolation between Tx and Rx of up to 27 dB due to the EMVDSRR absorbing the incident electromagnetic waves across its entire band. In some embodiments, the structure of unit cell 100 has the ability to absorb up to 95% of incident waves, making it an excellent candidate for use in full duplex applications.

The structure of unit cell 100 has a number of different parameters that may be varied to achieve different effects. The overall surface area of the unit cell 100 can be varied, which involves changing the size of the second layer 120 and the metallic layer 130. The amount of the surface area of the second layer 120 that is exposed, which is a function of the surface area of the first layer 110 with relation to the size of the second layer, may be varied. Within the first layer 110, there is defined void 114. The ratio of the surface area of layer 110 to the defined void 114 is another parameter that can be varied. The shape of void 114, and the shape of layer 110 are shown as squares or rectangles in the illustrations, but in some embodiments, they may take on different shapes. These various shapes, along with the shape of the second layer 120, may include circles, ovals, ellipsoids and other more complex shapes. The selection of the shape of each of void 114, layer 110 and layer 120 can also be a parameter than can be varied. The number of vias 112, the diameter of the vias 112, the pitch of the vias 112, and the amount of metal used to fill the vias 112 are also parameters that can be varied. In some embodiments, a via 112 may be partially filled with a metal, so that the full diameter of the via 112 is occluded, but the full height of the via 112 is not filled. In an alternate embodiment, the full height of a via 112 may be filled, but only a portion of the surface area of the via 112 can be filled. This may take the form of a semi-circularly filled via 112, or a via 112 that is filled but has a central cavity. Thus, the fill percentage of the via 112, and the geometry of a partial filling of the via 112 are also parameters that can be varied. In some embodiments, vias 112 may be differently shaped, such as having a square, oval, rectangle or other more complex shape as a cross-sectional area. The different shapes of a via 112 may also be a parameter to be varied.

In the following discussions, it will be apparent that absorption of the electromagnetic waves emitted by a transmitter may be achieved without introducing the third layer 125 and the fourth layer 115. In some implementations, this may result in a unidirectional absorption of radiated electromagnetic waves. In other implementations this may simply result in a reduced level of absorption.

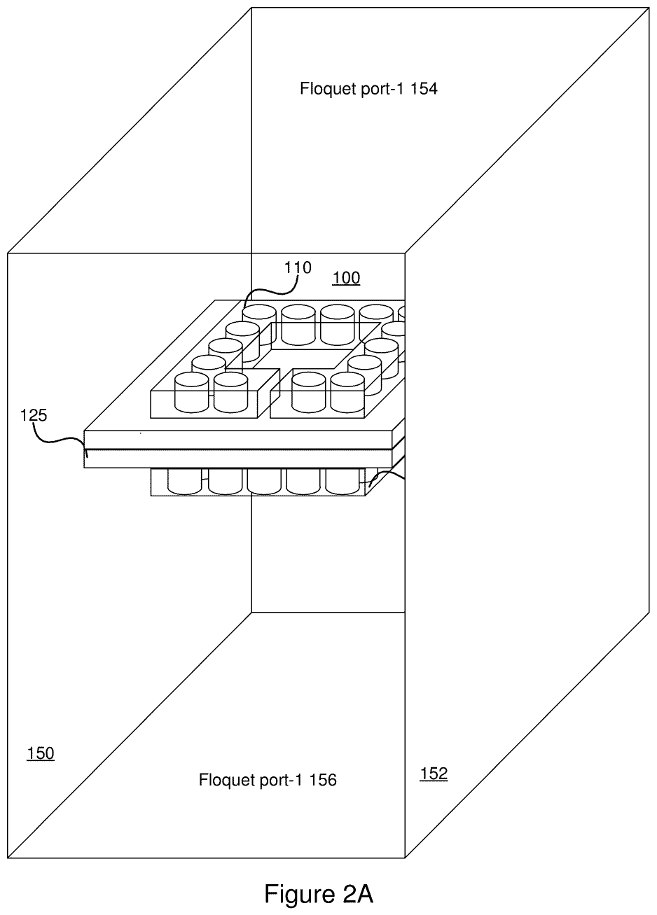

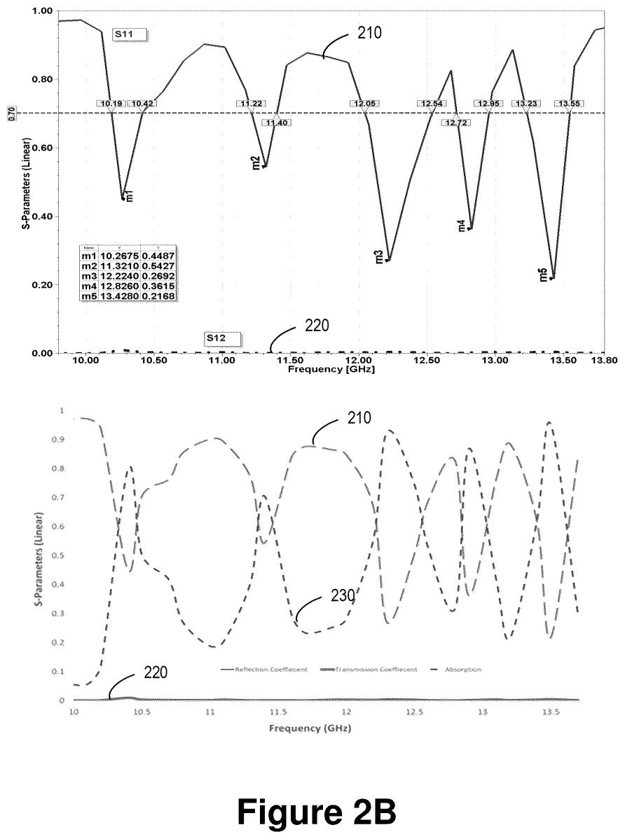

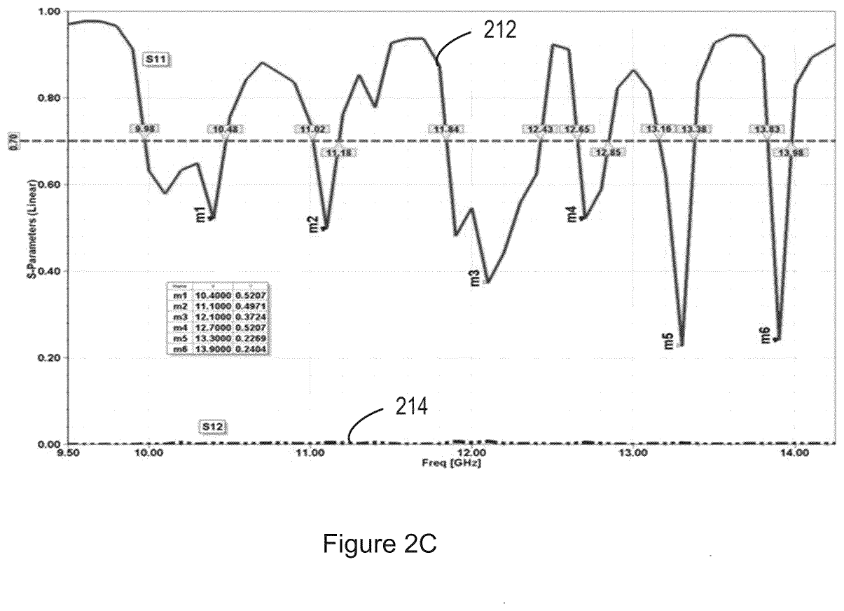

A property of some EMVDSRR structures is the absorption of electromagnetic waves, which can be utilized to have the unit cell 100 function as an absorption wall between transmission and reception points. FIG. 2A illustrates a schematic of the unit cell 100 with a boundary condition. The EMVDSRR unit cell 100 can be tested under the illustrated boundary conditions using a software simulation.

FIG. 2B illustrates graphs of the test results of the unit cell. The S-parameters (reflection and transmission coefficient) can be obtained, which are plotted as line 210 and line 220 respectively.

Line 210 represents the unit cell's return loss (S11), i.e., reflection coefficient. Line 220 represents transmission coefficient (S12). As can be seen, the unit cell has five operating bands: 10.19-10.42 GHz (m1=10.2675), 11.22-11.40 GHz (m2=11.3210), 12.05-12.54 GHz (m3=12.2240), 12.72-12.95 GHz (m4=12.8260), and 13.23-13.55 GHz (m5=13.4280).

In addition, an absorption ratio is also plotted as line 230. The absorption ratio is calculated by Formula (1):

$$Absorption ( A ) = 1 - ( S 11 ) \hat{} 2 - ( S 12 ) \hat{} 2 \qquad ( 1 )$$

For example, at frequency 10.26 GHz, S11=0.44, and S12=0, thus A=1−(0.44)\hat{ }2−(0)\hat{ }2=0.8. For example, at frequency 10.42 GHz, S11=0.7, and S12=0, thus A=1−(0.7)\hat{ }2−(0)\hat{ }2=0.51. For example, best absorption ratio or highest absorption ratio can be calculated at frequency 13.42 GHz, S11=0.21, and S12=0, thus A=1−(0.21)\hat{ }2−(0)\hat{ }2=0.95.

As illustrated, the transmission coefficient (S12), represented by line 220, is substantially zero so there is no transmission within this unit cell. As illustrated, the reflection coefficient (S11) is 0.7 through the band from 10.19 GHz to 10.42 GHz, that means about 51% of electromagnetic waves absorbed by the unit cell and about 80% absorbed at 10.26 GHz.

FIG. 2C illustrates a graph of some other test results of the unit cell 100. The S-parameters (reflection and transmission coefficient) can be obtained, which are plotted as line 212 and line 214 respectively.

Line 212 represents the unit cell's return loss (S11), i.e., reflection coefficient. Line 214 represents transmission coefficient (S12). As can be seen, the unit cell has six operating bands: 9.98-10.48 GHz (m1=10.4), 11.02-11.18 GHz (m2=11.1), 11.84-12.43 GHz (m3=12.1), 12.65-12.85 GHz (m4=12.7), 13.16-13.38 GHz (m5=13.3), and 13.83-13.98 GHz (m6=13.9). Once again, the S12 transmission coefficient is substantially zero across the plotted frequencies as shown by 214.

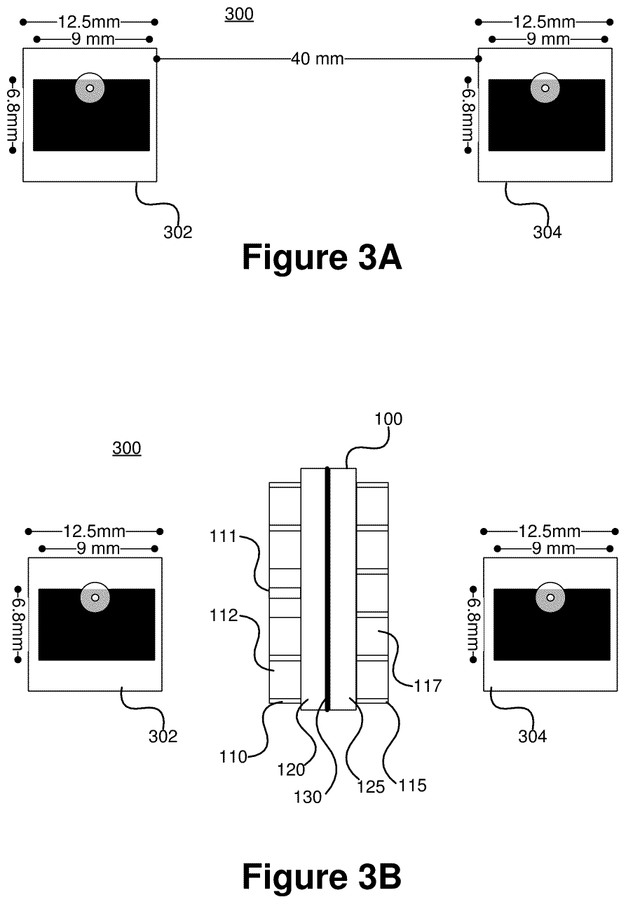

The present disclosure also provides, as shown in FIGS. 3A and 3B, an antenna system 300 in which a large number of transmitter and receiver elements are deployed, e.g., in a MIMO system. The antenna system 300 includes at least two antenna elements 302 and 304. In some implementations, such as that shown in FIG. 3B, the antenna system 300 further includes a unit cell 100. In some implementations, the unit cell 100 may be vertically oriented and placed between antenna 302 and antenna 304. In some implementations, the antenna system 300 may have first antenna 302 and second antenna 304 oriented so that they are co-polarized. In other embodiments, below, they may be oriented so that they are cross-polarized.

In FIG. 3A, two patch antennas 302 and 304 are oriented so that they are co-polarized. Each patch antenna 302, 304 has a square frame of size 12.5 mm per side, with a rectangular excitation element having edges with sides of 9 mm and 6.8 mm. Antennas 302 and 304 are placed 40 mm apart. Other dimension parameters of embodiments of an antenna system 300 may have values referred to in the illustrated figures.

FIG. 3A illustrates a schematic an array 300 of patch antennas 302 and 304 oriented so that they are co-polarized. There is no unit cell includes in FIG. 3A. In FIG. 3B, array 300 is shown with unit cell 100 placed between antennas 302 and 304. FIG. 3B thus shows a top view of array 300 in which patch antennas 302 and 304 in co-polarized with EMVDSRR unit cell 100 arranged therebetween. For example, the unit cell 100 with the EMVDSRR structure may be placed in the middle of the antennas 302 and 304, and may be regarded as an absorption wall or an isolation wall between antennas 302 and 304. As shown in FIG. 3B, unit cell 100 is oriented so that first layer 110 faces antenna 302, and fourth layer 115 faces antenna 304. The mid-way point of unit cell 100 is metallic layer 130, which would be situated 20 mm from each antenna 302 and 304.

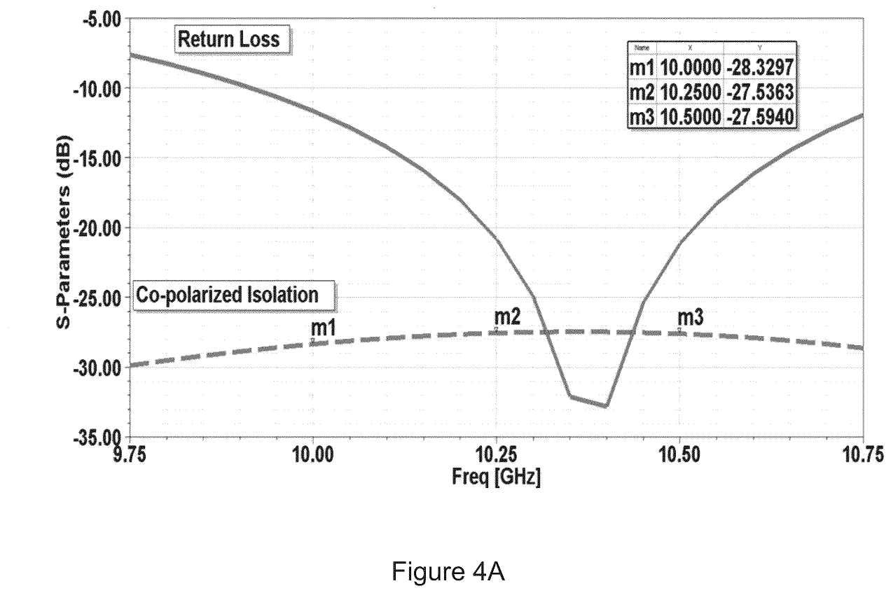

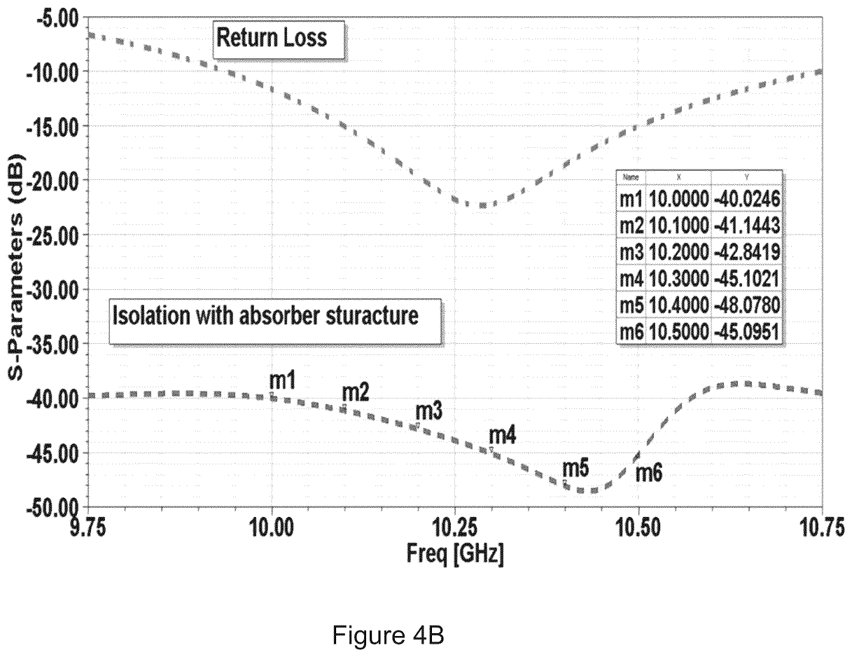

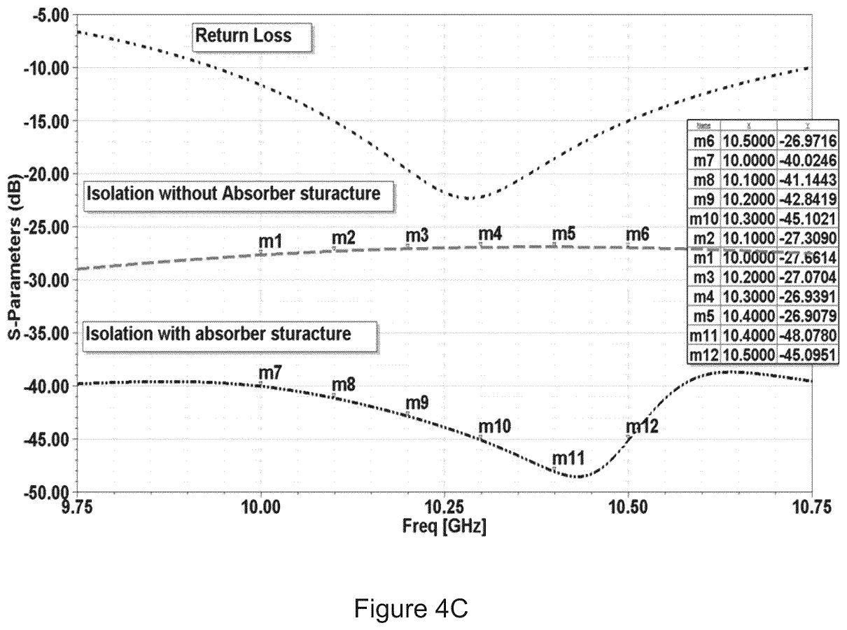

FIG. 4A illustrates a graph of S-parameter values vs. frequency of the Co-polarized antennas 302 and 304 as shown in FIG. 3A. As can be seen, the isolation at three frequencies—10 GHz, 10.25 GHz, and 10.5 GHz—is 28.3 dB, 27.5 dB, and 27.5 dB, respectively.

FIG. 4B illustrates a graph of S-parameter values vs frequency of the Co-polarized antennas 302 and 304 with EMVDSRR unit cell 100 there between as shown in FIG. 3B. The resulting isolation at six different frequencies—10 GHz, 10.1 GHz, 10.2 GHz, 10.3 GHz, 10.40 GHz and 10.50 GHz—is 40 dB, 41.1 dB, 42.8 dB, 45.1 dB 48 dB and 45 dB, respectively; with the average of 43.7 dB. In comparing these results, it is clear that the performance shown in FIG. 4B shows clearly improved isolation of antennas 302 and 304.

FIG. 4C illustrates an isolation comparison between antennas 302 and 304 oriented to be co-polarized with and without the presence of EMVDSRR unit cell 100 therebetween. As can be seen, the isolation between antennas 302 and 304 without the presence of EMVDSRR unit cell 100 therebetween at frequencies of 10 GHz, 10.1 GHz, 10.2 GHz, 10.3 GHz, 10.40 GHz and 10.50 GHz is 27.6 dB, 27.3 dB, 27 dB, 26.9 dB, 26.9 dB, and 26.9 dB, respectively. Without unit cell 100, antennas 302 and 304 have an average isolation of 27.6 dB. From the comparison illustrated in FIG. 4C, the placement of unit cell 100 between antennas 302 and 304 increases the average isolation by 16.1 dB.

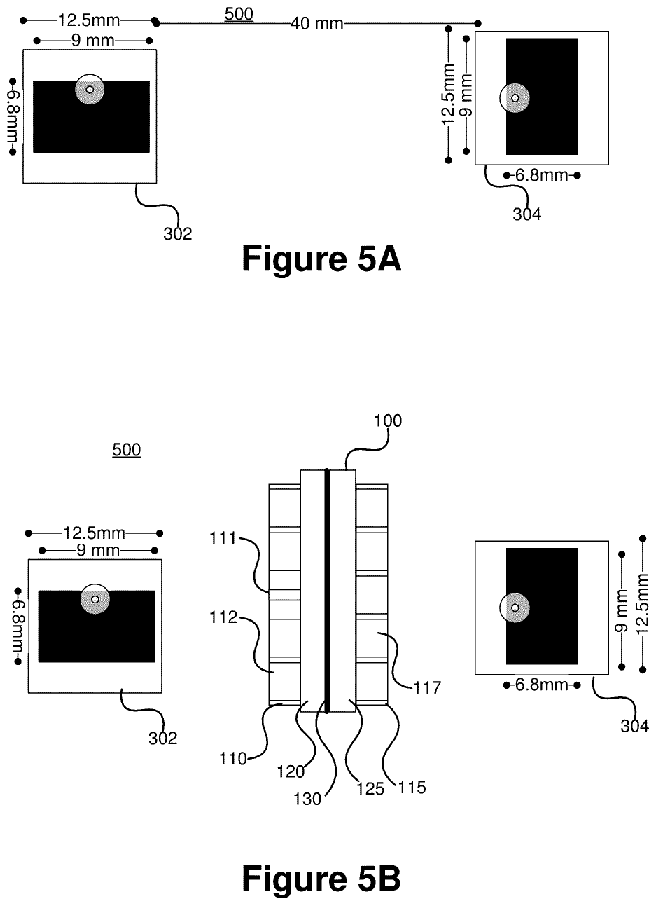

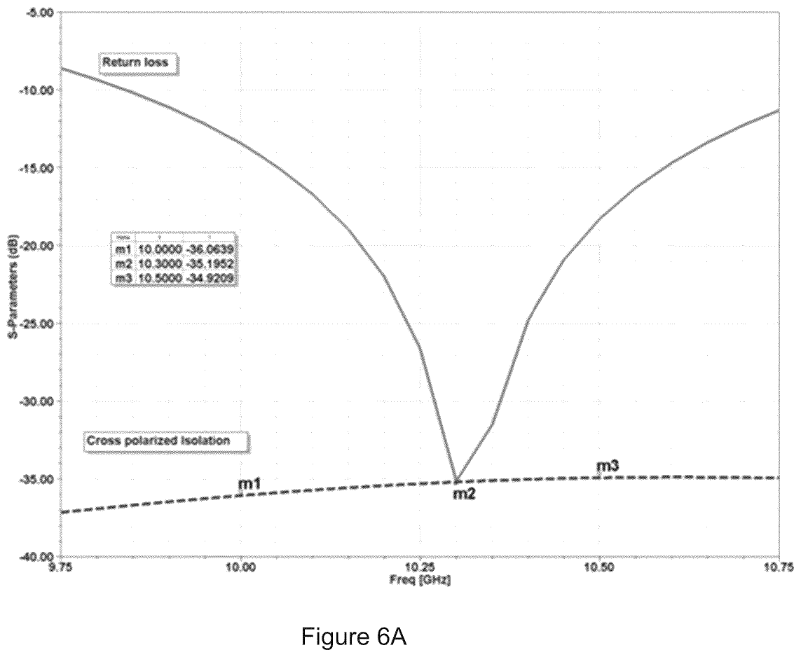

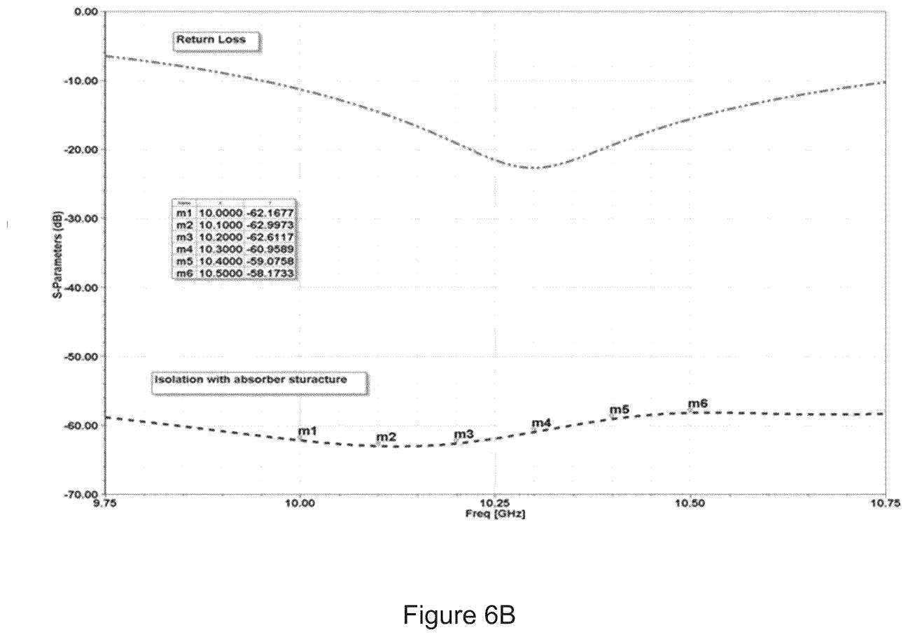

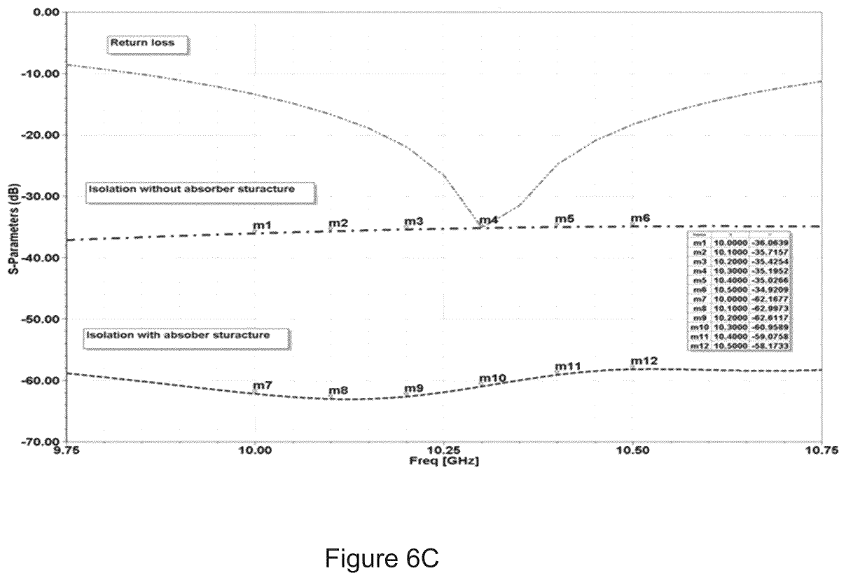

In the above discussion of array 300, two patch antennas 302 and 304 were oriented so that they were co-polarized. FIGS. 5A and 5B illustrate array 500 in which patch antennas 302 and 304 are oriented so that they are cross-polarized. As shown in FIG. 5A, once again the distance between the antennas is 40 mm. The dimension parameters, including the 40 mm distance between antennas 302 and 304, shown in FIG. 5A should be understood as examples of possible dimensions, but are the dimensions used for simulation to obtain the results as discussed below with reference to FIGS. 6A-6C.

FIG. 5A illustrates antenna system 500 in which two patch antennas, 302 and 304, are oriented to provide cross-polarization. Unit cell 100 is not present in FIG. 5A. In FIG. 5B, unit cell 100 is placed between cross-polarized antennas 302 and 304. FIG. 5B in (B), which shows a top view of cross-polarized patch antennas 302 and with EMVDSRR unit cell 100 placed therebetween. The EMVDSRR unit cell 100 is placed in the middle of the antennas 302 and 304, and may be regarded as an absorption wall or an isolation wall between the antennas. First layer 110 faces antenna 302, while fourth layer 115 faces antenna 304, with the middle of unit cell 100, metal layer 130, situated at the midpoint between antennas 302 and 304.

FIG. 6A illustrates S-parameters of the Cross-polarized antennas 302 and 304 shown in FIG. 5A. As can be seen, the isolation at three frequencies—10 GHz, 10.25 GHz, and 10.5 GHz—is 36 dB, 35.19 dB, and 34.92 dB, respectively.

FIG. 6B illustrates S-parameters of the Cross-polarized antennas 302 and 304 with an EMVDSRR unit cell 100 therebetween as shown in FIG. 5B. As a result of the absorbency of unit cell 100, the isolation of antennas 302 and 304 at six different frequencies—10 GHz, 10.1 GHz, 10.2 GHz, 10.3 GHz, 10.40 GHz and 10.50 GHz—is 62.1 dB, 62.9 dB, 62.6 dB, 60.9 dB, 59 dB and 58.1 dB, respectively. This results in an average isolation of 60.94 dB.

FIG. 6C illustrates an isolation comparison between two antennas 302 and 304 oriented so that they are cross-polarized with and without EMVDSRR unit cell 100 positioned therebetween. As can be seen, the isolation without EMVDSRR at the same six frequencies shown in FIG. 6B (10 GHz, 10.1 GHz, 10.2 GHz, 10.3 GHz, 10.40 GHz and 10.50 GHz) is 36 dB, 35.7 dB, 35.4 dB, 35.1 dB, 35 dB and 34.9 dB, respectively, resulting in an average isolation of 35.35 dB. From the comparison in FIG. 6C, it is evident that the addition of the unit cell 100 to array 500 result in the average isolation increasing by 25.25 dB.

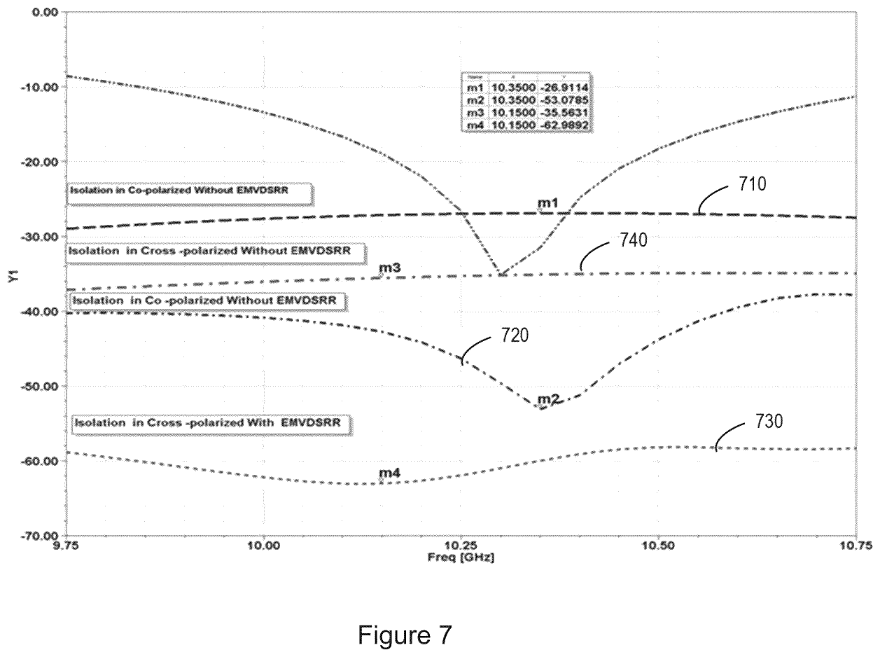

FIG. 7 illustrates a comparison of the isolation of antennas 302 and 204 from each other for four implementations. In series m1, shown in line 710, antenna 302 and 304 are arranged so that they are co-polarized and there is no unit cell 100 placed therebetween. In series m2, shown in line 720, antenna 302 and 304 are arranged so that they are co-polarized and there is a unit cell 100 there between. In series m3, shown in line 740, antenna 302 and 304 are arranged so that they are cross-polarized and there is no unit cell 100 placed therebetween. In series m4, as shown by line 730, antenna 302 and 304 are arranged so that they are cross-polarized and so that there is a unit cell 100 therebetween.

As can be seen from FIG. 7, the best isolation when the antennas are co-polarized with and without EMVDSRR is 26.17 dB at 10.35 GHz (illustrated as m1 and m2); and the best isolation in embodiments in which the antennas are cross-polarized with and without EMVDSRR is 27.48 dB at 10.15 GHz (illustrated as m3 and m4).

The above implementations provide a solution for improving isolation between antennas by using the unit cell 100. In some examples, the antennas may include a transmitter antenna and a receiver antenna, where the unit cell 100 is placed between the antennas. That is, the EMVDSRR structure can be easily inserted between transmitter and receiver antennas for reducing mutual coupling.

The unit cell 100 with the EMVDSRR structure in the above embodiments, as simulated, is able to absorb up to 95% of the incident electromagnetic waves, resulting in an increase in isolation of 27 dB. In summary, this unit cell structure achieves: (1) a high isolation capability of up to 27 dB; (2) absorbing up to 95% of electromagnetic waves; and (3) six operating frequency bands.

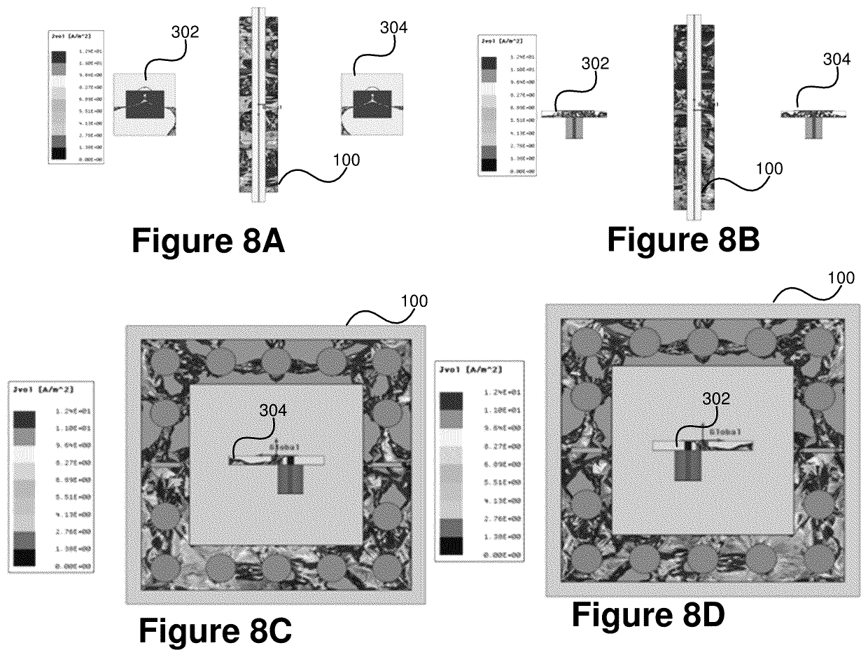

FIGS. 8A-8D, when taken together, illustrate the effect of unit cell 100 absorbing the electromagnetic radiation from co-polarized antenna. FIG. 8A shows a top view of the co-polarized antenna array 300 where antennas 302 and 304 have a unit cell 100 interposed between them. FIG. 8B illustrates a bottom view of array 300. FIG. 8C illustrates a right-side view of array 300, showing antenna 304 in front of unit cell 100. FIG. 8D illustrates a left side view of array 300, showing antenna 302 in front of unit cell 100. The shading of different regions of unit cell 100 indicate the intensity of the energy absorption according to the above-referenced computer simulations. Those skilled in the art will appreciate that in at least some embodiments, this correlates to an increase in the temperature of portions of unit cell 100. It can be seen that a large number of electromagnetic waves can be absorbed by the unit cell 100.

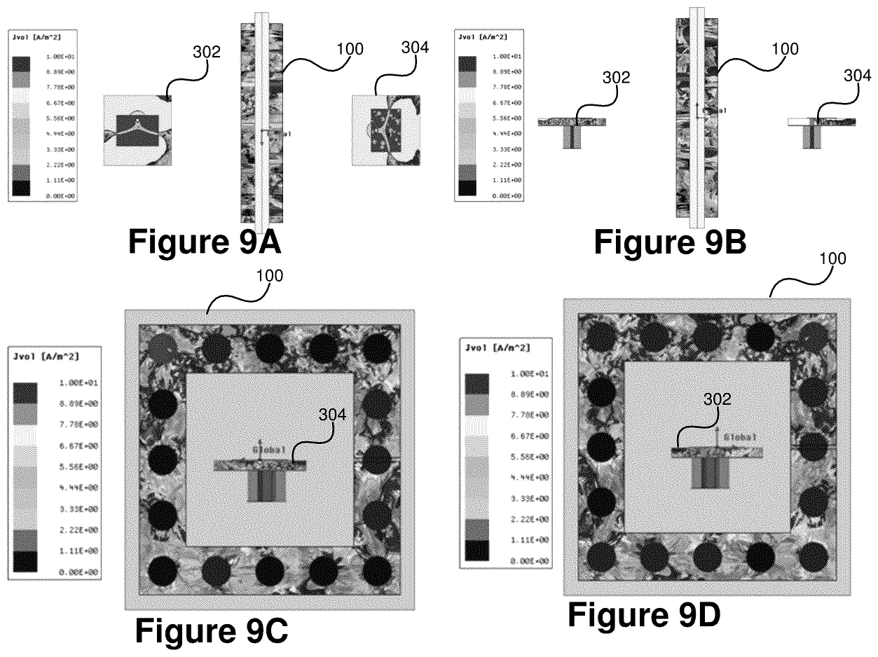

FIGS. 9A-9D, when taken together, illustrate the effect of unit cell 100 absorbing the electromagnetic radiation from cross-polarized antenna. FIG. 9A shows a top view of the cross polarized antenna array 500 in which antennas 302 and 304 have a unit cell 100 interposed between them, and where the antenna 302 and 304 are arranged to be cross polarized. FIG. 9B illustrates a bottom view of array 500. FIG. 9C illustrates a right-side view of array 500, showing antenna 304 in front of unit cell 100. FIG. 9D illustrates a left side view of array 500, showing antenna 302 in front of unit cell 100. The shading of different regions of unit cell 100 indicate the intensity of the energy absorption according to the above-referenced computer simulations. Those skilled in the art will appreciate that in at least some embodiments, this correlates to an increase in the temperature of portions of unit cell 100.

Multiple-band operation and enhanced coupling suppression are achieved through the Embedded Metal via in the Dielectric Split Ring Resonator, which can effectively operate on multiple bands while improving coupling suppression. Regarding electromagnetic wave absorption, the EMVDSRR effectively absorbs electromagnetic waves across various frequency bands through the resonant interactions between the induced currents and the incident electromagnetic waves.

The disclosed EMVDSRR structure may be used as a candidate for full-duplex applications in networks such as those supporting wireless networking protocols e.g., 5G and/or future generation (e.g., 6G) networking protocols. The unit cell having an EMVDSRR structure can be positioned between transceiver antennas to enhance isolation. For example, it can increase the isolation between any highly coupled components for system improvement.

The EMVDSRR structure has the capability to operate within multiple frequency bands as well as wide frequency ranges by tuning and controlling its parameters. For example, the number of operating frequency bands may be increased by changing size mentioned above, such as height, diameter, quality of vias, positions of vias, and/or dielectric constant of the dielectric material layers. Using such variations, it may be possible to make use of this as a resonant structure in other full-duplex communication systems including those designed to work with Wi-Fi based standards.

This EMVDSRR structure features the ability to absorb electromagnetic waves within its operating bands (e.g., about 10.25 GHz) by up to 95%. For example, this feature can be sued to protect equipment from unwanted electromagnetic waves.

The induced currents may be confined by the EMVDSRR structure, thus this feature may be used in many techniques, for instance, those intended to prevent reflections and radiation of energy including so-called stealth technology.

In addition, the unit cell features a simple symmetrical structure, low production cost, and ease of fabrication, while maintaining full compatibility with PCB technology.

In the above discussions, it will be understood that there has been disclosure of many embodiments, including disclosure of a unit cell in an antenna system that comprises a first layer and a second layer. The first layer is composed of a dielectric material having a plurality of metal vias arranged in a notched square, wherein a dielectric constant of the first layer is larger than a threshold. The second layer is positioned under the first layer, and has a dielectric constant smaller than that of the first layer. In some embodiments, the second layer is positioned above a metal layer. In a first disclosed embodiment, the antenna system comprises a third and fourth layer. The third layer is rotationally symmetric to the second layer, and the fourth layer is rotationally symmetric to the first layer. In some embodiments, the dielectric constant of the material in the first layer equals to or is larger than 10, and the dielectric constant of the second layer equals to or is smaller than 4.4. In other embodiments, the diameter of a metal via is 3.5 mm. In some embodiments, the plurality of metal vias features a distance of 6.48 mm between two adjacent vias. In some embodiments, the thickness of the first layer is 3 mm, and a thickness of the second layer is 1.6 mm. In other embodiments, a width of each frame of the notched square is 5.6 mm, and a slot width through a frame of the notched square is 0.2525 mm. In some embodiments, the second layer has a square with a length of 35 mm, and a distance from an outer edge of the first layer to an outer edge of the second layer is 1.75 mm.

It will be further understood that the above discussion further discloses an antenna system comprising a first and second antenna with a unit cell as described in the above embodiment positioned there between. In some embodiments, the unit cell is oriented to be perpendicular to a plane within which the first and second antenna are situated. In some such embodiments, the first and second antenna are arranged to be one of co-polarized and cross-polarized. In such configurations, the unit cell may absorb up to 95% of electromagnetic waves transmitted between the antenna to provide isolation of 27 dB between the first and second antenna. Such an arrangement of elements may provide up to six operating frequency bands. In some such arrangements, the first and second antenna are positioned with a distance therebetween of up to 40 mm.

It should be further understood that the antenna system described above may be embodied within, or connected to, a communications device.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

It is clearly that a person skilled in the art can make various modifications and variations to this application without departing from the scope of this application. This application is intended to cover these modifications and variations of this application provided that they fall within the scope of protection defined by the following claims and their equivalent technologies.

1. A unit cell comprising:
a first layer having a first dielectric constant, shaped to define a central void, and having a set of vias surrounding the central void; and
a second layer having a second dielectric constant lower than the first dielectric constant, having a surface area greater than a surface area of the first layer, and supporting the first layer; and
a metallic layer affixed to the second layer opposite the first layer.

2. The unit cell of claim 1 wherein the first and second layers is squares.

3. The unit cell of claim 1 wherein the central void is a square.

4. The unit cell of claim 1 wherein each via within the set of vias is equally spaced around the central void.

5. The unit cell of claim 1 wherein each via within the set of vias is at least partially filled with a metal.

6. The unit cell of claim 5 wherein the metal is the same composition as the metal within the metallic layer.

7. The unit cell of claim 1 wherein each via in the set of vias has the same cross-sectional shape.

8. The unit cell of claim 7 wherein the cross-sectional shape of a via is circular.

9. The unit cell of claim 1 wherein the first layer further comprises a slot exposing the central void.

10. The unit cell of claim 9 wherein the vias are equidistant from each neighboring via, except for the vias on opposite sides of the slot.

11. The unit cell of claim 1 wherein the first layer is centered upon the second layer.

12. The unit cell of claim 1 wherein the metallic layer is the same size and surface area as the second layer.

13. The unit cell of claim 1 further comprising:
a third layer affixed to the metallic layer and opposite the second layer, having a third dielectric constant; and
a fourth layer, supported by the third layer, having a dielectric constant higher than the third dielectric constant, shaped to define a central void, and having a set of vias surrounding the central void.

14. The unit cell of claim 13 wherein the first and fourth layer have the same dielectric constant, and wherein the second and third layers have the same dielectric constant.

15. The unit cell of claim 13 wherein each of the first and fourth layers are squares defining a square shaped central void.

16. The unit cell of claim 1 wherein each via in the plurality of metal vias has a circular cross section of 3.5 mm, and adjacent vias are 6.48 mm apart.

17. A communication device comprising an antenna system, the antenna system comprising: a first antenna, a second antenna, and a unit cell interposed therebetween, the unit cell further comprising:
a first layer having a first dielectric constant, shaped to define a central void, and having a set of vias surrounding the central void;
a second layer having a second dielectric constant lower than the first dielectric constant, having a surface area greater than a surface area of the first layer, and supporting the first layer; and
a metallic layer affixed to the second layer opposite the first layer, wherein the unit cell is placed perpendicularly to a plane between the first and second antennas.

18. An antenna system comprising: a first antenna, a second antenna, and a unit cell interposed therebetween, the unit cell further comprising:
a first layer having a first dielectric constant, shaped to define a central void, and having a set of vias surrounding the central void;
a second layer having a second dielectric constant lower than the first dielectric constant, having a surface area greater than a surface area of the first layer, and supporting the first layer; and
a metallic layer affixed to the second layer opposite the first layer, wherein the unit cell is placed perpendicularly to a plane between the first and second antennas.

19. The antenna system of claim 18 wherein the first antenna is arranged to be one of co-polarized and cross-polarized, with the second antenna.

20. The antenna system of claim 18 wherein the unit cell is interposed between the first antenna and the second antenna, to absorb electromagnetic waves transmitted between the first and second antennas to provide 27 dB of isolation.
